(19) United States
(12) Patent Application Publication
(10) Pub. No.: US 2009/0158426 A1
(43) Pub. Date: Jun. 18, 2009

(54) TRACEBACK METHOD AND SIGNAL RECEIVING APPARATUS

(75) Inventors: Byung Sik YOON, Daejeon (KR); Do Hoon Kim, Seoul (KR); Hoh Peter In, Seoul (KR); Song In Choi, Daejeon (KR); Jee Hwan Ahn, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/173,411

(22) Filed: Jul. 15, 2008

(30) Foreign Application Priority Data
Dec. 17, 2007 (KR) 10-2007-0132622

(51) Int. Cl. H04L 9/00; G06F 15/16

(52) U.S. Cl. 726/22

(57) ABSTRACT

The present invention provides a traceback method including: receiving data including router information according to a path of an attacker; filtering the data to hash the data, and storing the resultant hashed information; determining whether the data is normally received on the basis of the hashed information; and predicting a path loss on the basis of the determination result. Therefore, it is possible to perform an accurate IP traceback using a probabilistic packing marking method and a hash-based traceback method.

### CROSS-REFERENCE TO RELATED APPLICATION

This application claims priority to and the benefit of Korean Patent Application No. 10-2007-0132622 filed in the Korean Intellectual Property Office on Dec. 17, 2007, the entire contents of which are incorporated herein by reference.

### BACKGROUND OF THE INVENTION

(a) Field of the Invention

The present invention relates to a traceback method. Particularly, the present invention relates to a method based on a Markov chain model.

The present invention was supported by the IT R&D program of MIC/IITA [2006-S-009-02, Development of WiBro Service and Operation Standard].

(b) Description of the Related Art

Tracebacks in an IP (Internet protocol) layer that deal with the transmission of packets over a network are classified into a proactive IP traceback and a reactive IP traceback. In addition, the tracebacks are classified into a router-based traceback, a technique for implementing a management system for packet information, a traceback based on a specific network, and a traceback based on a management technique.

The proactive IP traceback includes two representative methods, that is, a probabilistic packet marking method and an Internet control message protocol (ICMP) traceback method.

In the probabilistic packet marking method, two routers adjacent to a path of packets mark their information on the packets with a predetermined probability, and find an attack source on the basis of the information marked on the packets when a distributed denial of service (DDoS) attack occurs.

The probabilistic packet marking method probabilistically marks information on the packets to reduce the overhead of the router and to minimize a marking size. Therefore, the probabilistic packet marking method can solve the problems of the traceback due to fragmentation.

The ICMP traceback method copies the content of a specific ICMP traceback message and forwards the copied message to all the routers. The ICMP traceback method can efficiently access the routers, but has a disadvantage in that an attacker will transmit a fraudulent ICMP traceback message to a victim host.

A hash-based traceback method is a representative example of the reactive IP traceback. In the hash-based traceback method, a source patch isolation engine (SPIE)-based traceback server is provided, the entire network is classified into sub-groups, and an agent is provided for each of the sub-groups, thereby managing the network. Each router has a data generation agent (DGA) function. The DGA function applies a hash function to packet information transmitted to each router to hash the packet information. That is, the hash-based traceback method stores and manages IP header information and payload information, and generates a database using a Bloom filter having a hash-based data structure.

If a destination intrusion detection system detects hacking and an illegal act, the agent managing the network group compares information stored in a DGA router in the group with hacking packet information, analyzes the comparison result, and transmits the analyzed result to an SPIE system, thereby reconstructing a transmission path of the packet related to the hacking.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a traceback method having an advanced traceback performance, which is a combination of a proactive traceback method and a reactive traceback method.

According to an aspect of the present invention, a traceback method includes: receiving data including router information according to the path of an attacker; filtering the data to hash the data, and storing the hashed information; determining whether the data is normally received on the basis of the hashed information; and predicting a path loss on the basis of the determination result.

The router information may be included in the data by probabilistic packet marking.

The router information may be marked on the data by a transition probability corresponding to a router.

The router information of a plurality of routers may include the results obtained by performing an exclusive OR operation on IDs of the plurality of routers.

The filtering and storing of the information may include separating an Internet protocol header and query information from the data using a Bloom filter, and storing the Internet protocol header and the query information.

The determination of whether the data is normally received on the basis of the hashed information may include examining the Internet protocol header to determine whether the data is normally received.

The determination of whether the data is normally received on the basis of the hashed information may include, when it is determined that the data is abnormally received, predicting the path loss.

The predicting of the path loss may include setting the plurality of routers as nodes, generating a transition probability matrix on the basis of the transition probabilities of the nodes, generating the incidence of each of the nodes on the basis of the transition probability matrix, and determining priorities of the nodes on the basis of the incidences.

The determination of whether the data is normally received may include determining whether there is router information.

According to another aspect of the present invention, a signal receiving apparatus includes: a receiver that receives data including router information according to the path of an attacker; a filter that groups the data and classifies acknowledgement information of the groups; a storage unit that stores the acknowledgement information; and a determining unit that determines whether the data is normally received on the basis of the acknowledgement information and predicts the path of the attacker.

The acknowledgement information may include mobile router information of the attacker.

The mobile router information may be included in the data according to Markov chain-based probabilistic packet marking.

The router information may include a transition probability corresponding to a router.

The router information of a plurality of routers may be generated by performing an exclusive OR operation on IDs of the plurality of routers.

The acknowledgement information may include an Internet protocol header and query information.

The determining unit may examine the Internet protocol header to determine whether the data is normally received.

When it is determined that the data is abnormally received, the determining unit may predicts the path loss.

The determining unit may calculate the incidence of each of the routers on the basis of a transition probability matrix for the plurality of routers and determine priorities of the routers on the basis of the incidences.

The determining unit may determine whether the data is normally received on the basis of whether there is the router information.

According to the above-mentioned aspects of the present invention, it is possible to perform an accurate IP traceback using a probabilistic packing marking method and a hash-based traceback method.

### BRIEF DESCRIPTION OF THE DRAWINGS

FIG. 1 is a diagram illustrating data hacking in a broadband wireless Internet system according to the present invention.

FIGS. 2A to 2C are diagrams illustrating a process of marking router IDs according to the movement of an attacker.

FIG. 3 is a diagram illustrating the path of the attacker in a network graph.

FIG. 4 is a diagram schematically illustrating the structure of a router of a victim host.

FIG. 5 is a flowchart illustrating a traceback operation of the router of the victim host.

FIGS. 6A and 6B are diagrams illustrating a method of predicting an expected path shown in FIG. 5.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

In the specification, a terminal may be referred to as a mobile station (MS), a mobile terminal (MT), a subscriber station (SS), a portable subscriber station (PSS), user equipment (UE), or an access terminal (AT). The terminal may include some or all of the functions of the mobile terminal, the subscriber station, the portable subscriber station, and the user equipment.

In the specification, a node may be referred to as a base station (BS), an access point (AP), a radio access station (RAS), a node B, a base transceiver station (BTS), or a mobile multihop relay (MMR)-BS. The node may include some or all of the functions of the access point, the radio access station, the node B, the base transceiver station, and the MMR-BS.

Hereinafter, a traceback method using a Markov chain model will be described.

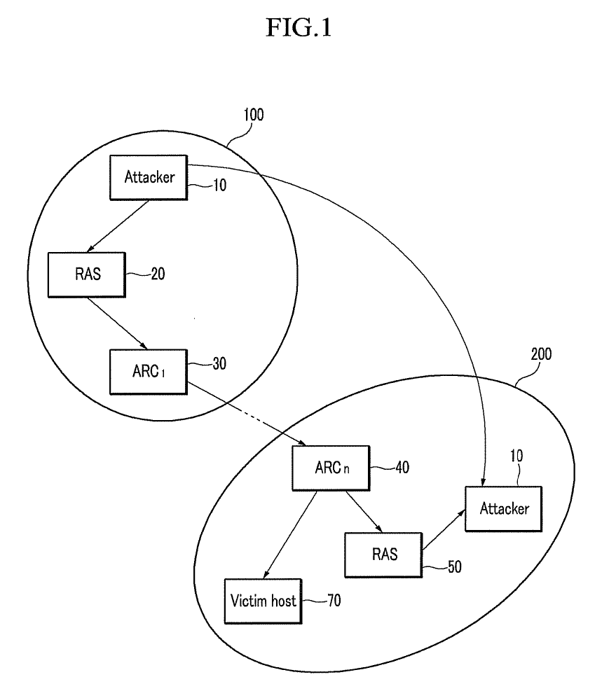

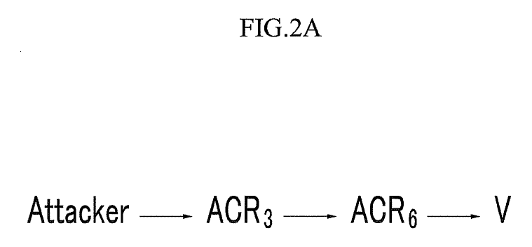

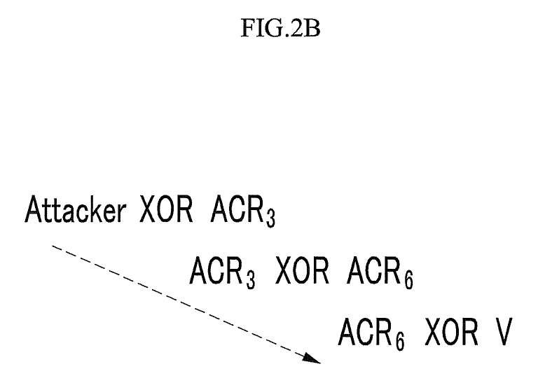

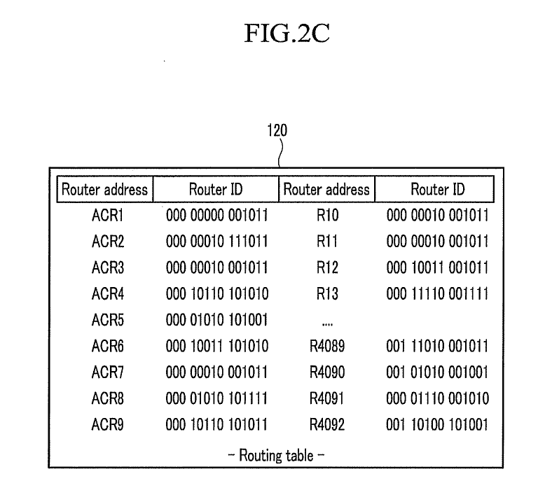

FIG. 1 is a diagram illustrating data hacking in a broadband wireless Internet system according to the present invention, and FIGS. 2A to 2C are diagrams illustrating a process of marking a router ID according to the movement of an attacker.

Referring to FIG. 1, an access network 100 includes a mobile station 10, a radio access station (RAS) 20, and a router 30.

The router (ACR₁) 30 is for connecting separated networks using the same transmission protocol. The router 30 connects network layers, and has functions of packet switching, packet forwarding, packet filtering, and routing.

The radio access station 20 transmits signals generated by the mobile station 10, and registers positional information for checking the position of the mobile station 10 existing in the access network 100 controlled by the radio access station 20.

The router 30 of the radio access station 20 controlling the access network 100 including the mobile station 10 generates a binary router ID to perform marking.

That is, the router 30 stores router information of received request packet data, marks the router ID on the router information of response packet data, and transmits the response packet data.

Meanwhile, as shown in FIG. 1, when the mobile station 10 of the attacker moves from one access network to another network, a handover occurs. When the mobile station of the attacker reaches an access network 200, which is a final destination, after a plurality of handovers occur, the mobile station of the attacker has an effect on a victim host 70 of the access network 200. Here, the access network 200 includes a router (ACRₙ) 40 and a radio access station (RAS) 50.

As shown in FIG. 2A, when the mobile station 10 of a hacker is handed over to a network including a router V of a victim host through the third and sixth routers ACR₃ and ACR₆, router IDs of the path are continuously marked on an option field of an IP header of packet data by an exclusive OR operation, as shown in FIG. 2B.

The router ID is represented by an arbitrary binary value, as shown in FIG. 2C.

In this case, the routers ACR₃ and ACR₆ on the path perform probabilistic packet marking using the Markov chain on the router IDs.

The state of each of the routers through which the mobile station passes for probabilistic packet marking may be represented by the following set:

{??, ACR₃, ACR₆, (V), ACR₃ and ACR₆, (ACR₆, V), (ACR₃, V), (ACR₃, ACR₆, V)}.

In this case, each state has a transition probability, and a transition probability matrix may be formed on the basis of the transition probability and a total number of transitions.

The transition probability between the router to which the attacker belongs first and the third router ACR₃ and the transition probability between the sixth router ACR₆ and the router V of the victim host are calculated.

The calculation of the transition probabilities satisfy Equation 1 given below:

P(T(G)=ACRᵢ)=(the number of sources reached ACRᵢ)/the total number of sources*[Pₘ(1−Pₘ)^{d(ACRi, v)-1}. [Equation 1]

In addition, the calculation satisfies

$$P ( T ( G ) = φ ) = 1 - {\sum }_{i = 1}^{n} P ( T ( G ) = {ACR}_{i} ) ,$$

(where T(G) indicates a packet type in a network graph G, ACRᵢ indicates an i-th router in the network graph G, Pm indicates the probability marking values of all routers (1/d), d indicates the distance between the router and a victim host that is most distant from the router, and d(ACRᵢ, v)−1 indicates the distance between the victim host V and ACRi).

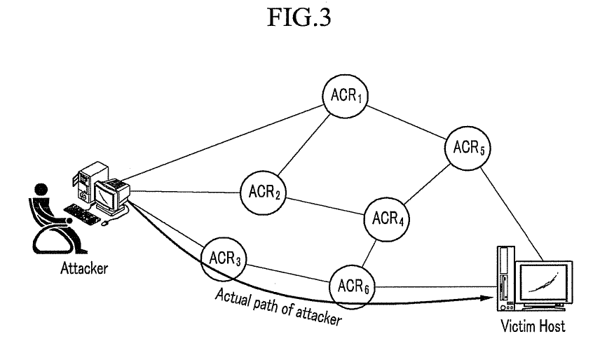

FIG. 3 is a diagram illustrating the path of an attacker in the network graph.

When the mobile station 10 of the attacker performs a plurality of handovers and the router V of the last victim host is defined through the first router ACR₁, the third router ACR₃, and the sixth router ACR₆, the router V of the victim host traces back the IP of the attacker.

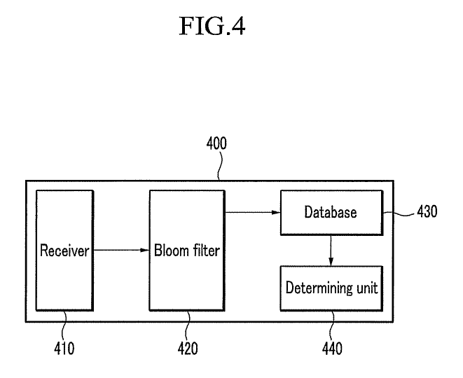

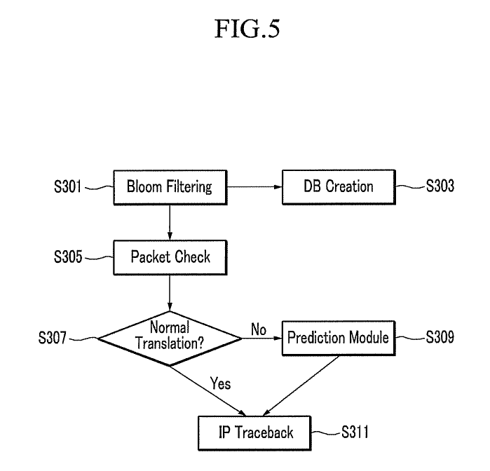

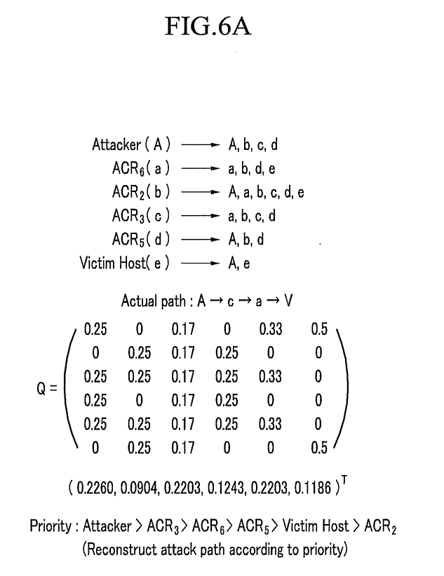

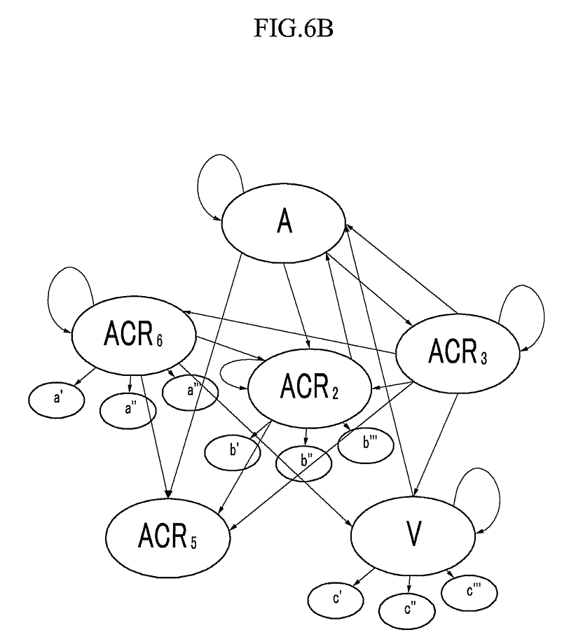

FIG. 4 is a diagram schematically illustrating the structure of the router of the victim host, FIG. 5 is a flowchart illustrating a traceback operation of the router of the victim host, and FIGS. 6A and 6B are diagrams illustrating a method of predicting an expected path of FIG. 5.

Referring to FIG. 4, a router 400 of a victim host includes a receiver 410, a Bloom filter 420, a database 430, and a determining unit 440.

When a victim host is defined, the router 400 of the victim host receives data packets using the receiver 410, filters the data packets using the Bloom filter 420, and hashes the filtered data packets (S301). Then, the router 400 stores the hashed data in the database 430 (S303).

The Bloom filter 420 allows a predetermined amount of false positives to make up for the defects of the hash function. Therefore, it is important to reduce the false positives. Therefore, it is determined only whether there is a router ID, but it is not determined whether to store the router ID in its original form, which makes it possible to store a large amount of data information using a small database 430.

Then, the determining unit 440 searches interested query information from the stored data to know the packet type and the storage format of the stored data. The determining unit 440 uses them to generate information for IP traceback (S305).

Then, the determining unit 440 examines the IP header of the stored data to determine whether the data is normally transmitted (S307).

When it is determined that the data is normally transmitted, the determining unit 440 immediately perform the IP traceback (S311). When it is determined that a transmission loss occurs, the determining unit 440 finds a lost portion using a prediction module and then performs a traceback (S309).

In order to find the lost portion, the determining unit sets each router in the network graph G shown in FIG. 3 as a node, and calculates the transition probability between the nodes with the number of nodes increased as shown in FIG. 6B, and calculates a transition probability matrix Q.

As shown in FIG. 6A, the transition probability matrix Q is operated on the initial probability of each node to calculate the incidence of each node.

When the second to sixth routers between the first router of the attacker and the router of the victim host are set as nodes and the incidence of each node is calculated, (0.2260, 0.0904, 0.2203, 0.1243, 0.2203, 0.1186)^{T} shown in FIG. 5A is obtained.

When the incidences are arranged in ascending order, it is possible to know priorities in ascending order, and it is possible to perform a traceback by determining the priorities as the path of the attacker.

When the IP traceback is actually implemented as shown in FIGS. 6A and 6B, the priorities are set in the order of Attacker>ACR₃>ACR₆>ACR₅>Victim Host>ACR₂, which correspond to the actual route.

Therefore, if marking is not performed due to the packet loss of the router ACR₆, the router ACR₅ may also be considered to have the highest probability of a packet loss. Therefore, it is possible to exclude other routes from the traceback.

As such, it is possible to reconstruct a transmission path in consideration of both whether a transmission loss occurs and whether packets are normally transmitted. Therefore, this embodiment is more effective than the traceback method according to the related art.

The above-described exemplary embodiment of the present invention can be applied to programs that allow computers to execute functions corresponding to the configurations of the exemplary embodiments of the invention or recording media including the programs as well as the method and apparatus. Those skilled in the art can easily implement the applications from the above-described exemplary embodiments of the present invention.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A traceback method comprising:
receiving data including router information according to a path of an attacker;
filtering the data to hash the data, and storing resultant hashed information;
determining whether the data is normally received on the basis of the hashed information; and
predicting a path loss on the basis of the determination result.

2. The traceback method of claim 1, wherein the router information is included in the data by probabilistic packet marking.

3. The traceback method of claim 2, wherein the router information is marked on the data by a transition probability corresponding to a router.

4. The traceback method of claim 3, wherein the router information of a plurality of routers includes results obtained by performing an exclusive OR operation on IDs of the plurality of routers.

5. The traceback method of claim 4,
wherein the filtering and storing of the information includes:
separating an Internet protocol header and query information from the data using a Bloom filter; and
storing the Internet protocol header and the query information.

6. The traceback method of claim 5,
wherein the determination of whether the data is normally received on the basis of the hashed information includes
examining the Internet protocol header to determine whether the data is normally received.

7. The traceback method of claim 6, wherein the determination of whether the data is normally received on the basis of the hashed information includes,
when it is determined that the data is abnormally received, predicting the path loss.

8. The traceback method of claim 7,
wherein the predicting of the path loss includes:
setting the plurality of routers as nodes;
generating a transition probability matrix on the basis of transition probabilities of the nodes;
generating the incidence of each of the nodes on the basis of the transition probability matrix; and
determining priorities of the nodes on the basis of the incidences.

9. The traceback method of claim 8, wherein the determination of whether the data is normally received includes determining whether there is router information.

10. A signal receiving apparatus comprising:
a receiver that receives data including router information according to a path of an attacker;
a filter that groups the data and classifies acknowledgement information of the groups;
a storage unit that stores the acknowledgement information; and
a determining unit that determines whether the data is normally received on the basis of the acknowledgement information and predicts the path of the attacker.

11. The signal receiving apparatus of claim 10, wherein the acknowledgement information includes mobile router information of the attacker.

12. The signal receiving apparatus of claim 11, wherein the mobile router information is included in the data according to Markov chain-based probabilistic packet marking.

13. The signal receiving apparatus of claim 12, wherein the router information includes a transition probability corresponding to a router.

14. The signal receiving apparatus of claim 13, wherein the router information of a plurality of routers is generated by performing an exclusive OR operation on IDs of the plurality of routers.

15. The signal receiving apparatus of claim 14, wherein the acknowledgement information includes an Internet protocol header and query information.

16. The signal receiving apparatus of claim 15, wherein the determining unit examines the Internet protocol header to determine whether the data is normally received.

17. The signal receiving apparatus of claim 16, wherein, when it is determined that the data is abnormally received, the determining unit predicts a path loss.

18. The signal receiving apparatus of claim 17, wherein the determining unit calculates the incidence of each of the routers on the basis of a transition probability matrix for the plurality of routers and determines priorities of the routers on the basis of the incidences.

19. The signal receiving apparatus of claim 18, wherein the determining unit determines whether the data is normally received on the basis of whether there is router information.
